(19) United States
(12) Patent Application Publication
(10) Pub. No.: US 2010/0072868 A1
(43) Pub. Date: Mar. 25, 2010

(54) CABINET DOOR SYSTEM

(75) Inventors: Randy O. Deem, Perry, UT (US); Kip W. Deem, Perry, UT (US); Russell O. Deem, Harrisville, UT (US); Nathan R. Deem, Brigham City, UT (US); John W. Packer, Brigham City, UT (US); Dustin E. Yates, Brigham City, UT (US); Ryan B. Eddington, Perry, UT (US); Tim B. Bair, Brigham City, UT (US); Nathan D. Hall, Brigham City, UT (US)

Correspondence Address: ADVANTIA LAW GROUP, 9035 SOUTH 1300 EAST, SUITE 200, SANDY, UT, 84094, US

(73) Assignee: ANVIL CONSTRUCTION, INCORPORATED, Brigham City, UT (US)

(21) Appl. No.: 12/234,583

(22) Filed: Sep. 19, 2008

(51) Int. Cl. E05F 15/16; E05F 15/18; E06B 3/44

(52) U.S. Cl. 312/319.7; 312/319.5; 49/126

(57) ABSTRACT

An automated door system comprising a plurality of overlapping horizontal slats; wherein the plurality of overlapping slats are individually selectably removable. The plurality of overlapping horizontal slats further comprise an inward stair-step configuration. In addition, the system further comprises a control module, wherein the control module includes a touch screen interface. Furthermore, the system still further comprises a lifting system coupled to the plurality of slats and in communication with the control module; wherein the lifting system is configured to raise and lower the plurality of slats. The lifting system further comprises a rotor coupled to a stepped wheel and a pulley system configured to raise and lower the plurality of slats. The lifting system further comprises a plurality of tracks configured to guide the plurality of slats when raised and lowered.

### BACKGROUND OF THE INVENTION

1. Field of the Invention

The present invention relates to cabinets, specifically an automated cabinet door system configured to provide selectable access to contents stored therein

2. Description of the Related Art

In the related art, it has been known a cabinet including hands free opening. Hands free is an adjective describing equipment that can be used without the use of hands or, in a wider sense, equipment which needs only limited use of hands, or for which the controls are positioned so that the hands are able to occupy themselves with another task without needing to hunt far-a-field for the controls. Devices that are typically used for hands free communication use Bluetooth as its wireless technology.

Some improvements have been made in the field. Examples of references related to the present invention are described below, and the supported teachings of each reference are incorporated by reference herein:

U.S. Pat. No. 4,231,191, issued to Ellmore, discloses a door opener system which includes a compact unit containing a motor, circuitry and various accessories, which can be quickly connected to and disconnected from the operator system, said motor having a first gear which easily is positioned into a meshing relationship with a second gear upon connection of the compact unit to the operator system. The operator system further includes the use of only two common switch actuators for operating the motor to move the door in open and closed positions, and to stop the motor upon the door striking an obstruction in its path of travel, said actuators being cooperatively associated with a cam actuator and drive chain pressure responsive means. Also, a unitary gear and drive sprocket structure is utilized in the drive system. Finally, an adjustable shock absorber type draw bar interconnects the door to the chain drive.

U.S. Pat. No. 5,247,232, issued to Lin, discloses a garage door control device that will automatically open or close depending upon conditions, the device having a motion detector responsive to vehicle space for actuating security lighting and warning measures, and a sound detector co acting with the motion detector and a garage entry door sensor to provide enablement of the door closure activator during respective exiting and non-exiting modes.

U.S. Pat. No. 3,874,117, issued to Boehm, discloses an electric door opener to be utilized in conjunction with a standard door closer or door check to provide the elements of automatic door control. The door opener is typically mounted on the transom of the door and includes an electric motor having a drive shaft that operates through a worm gear mechanism and an electromagnetic clutch to drive a gear train. The output of the gear train is operable connected to a linkage attached to the door. An approach switch, associated with an approach mat or a photoelectric eye, is located ahead of the door, while a safety switch is similarly associated with a safety mat or photoelectric eye located behind the door. With the closing of the approach switch by a pedestrian approaching the door, high voltage power is supplied to the motor and clutch to enable the motor to drive the gear train and pivot the linkage to move the door to the open position. In addition, closing of the approach switch will also supply low voltage power to the motor. When the door is in the full open position a limit switch is actuated which acts to remove high voltage power from the motor, leaving only low voltage power on the motor. The low voltage power supplied to the motor is sufficient to overcome the force of the door closer and maintain the door in the open position. A time delay is incorporated in the system which provides time for pedestrian movement from the approach mat to the safety mat, and to clear the safety mat before the door closes.

U.S. Pat. No. 6,346,889, issued to Moss, discloses a system and device for insuring the integrity of an automatic garage door has a sensor to determine the status of the door with respect to a predetermined position and a programmable actuator which provides a positive signal for automatically activating a warning or alert system when the door is in predetermined position when the programmable actuator is activated and the sensor indicates that the door is at other than the predetermined position. Preferably the programmable actuator is a timer and the predetermined position is closed. The timer can be remotely programmable. The actuator can also be triggered by a sensor of an event such as darkness. Remote means are provided for manually activating the door to return to the desired position by an RF frequency transmitter.

U.S. Pat. No. 4,543,746, issued to Racca, discloses sliding doors, particularly for railway and tramway vehicles, comprise two opposing doors which are movable relative to a doorway between an emplaced closed position and a withdrawn open position by guide means and motorized drive means. The drive means include a motorized chain transmission connected to the two doors to effect their opening and closing sliding movements, and rotatable cam means defining, for each door, an arcuate track with which feeler means connected to the two doors cooperate to effect, in the initial phase of the opening sliding movement and in the final phase of the closing sliding movement of these doors respectively, the withdrawal and the emplacement of the doors relative to the doorway.

U.S. Pat. No. 6,938,372, issued to Kennedy et al., discloses a mine door assembly has a frame. At least one door leaf is mounted on the frame for swinging movement between open and closed positions. Movement of the door leaf is powered by a pneumatic actuator. The door installation also has a hydraulic checking system for controlling the speed of the door leaf as it moves back and forth between open and closed positions. A pneumatically-powered control system may be provided to control the door installation. The pneumatic control system may comprise a calibrated vent to shorten the delay in the response of the door leaf to direction from the control system to stop moving. The pneumatic control system may also comprise a limit valve to prevent the door installation from opening when a second door installation is open, thereby preventing both door installations in an air lock from being open at the same time.

The inventions heretofore known suffer from a number of disadvantages which include being difficult to use, being limited in application, being limited in adaptability, being limited in versatility, being complex, being impractical, and being unappealing.

What is needed is an automated cabinet door system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available automated cabinet systems. Accordingly, the present invention has been developed to provide an efficient and elegant automated cabinet door system.

In one embodiment, there is an automated door system configured to provide selectable access to contents stored therein; the system may comprise a plurality of overlapping horizontal slats. The plurality of overlapping slats may be individually selectably removable; wherein the plurality of overlapping horizontal slats may further comprise an inward stair-step configuration. In addition, the plurality of overlapping horizontal slats may further comprise a transparent surface. The system may also include a control module configured to selectably provide control instructions; wherein the control module may further comprises a touch screen interface. The control module may still further comprise a program module, in communication with the touch screen interface, configured to provide programmable control instructions. The system may still further comprise a lifting system coupled to the plurality of slats and in communication with the control module. The lifting system may be configured to raise and lower the plurality of slats according to the control instructions; wherein the lifting system may further comprise a rotor coupled to a stepped wheel and a pulley system configured to raise and lower the plurality of slats. The lifting may still further comprise a plurality of tracks configured to guide the plurality of slats when raised and lowered according to the control instructions.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a cabinet system according to one embodiment of the invention;

FIG. 2 is a block diagram illustrating an automated vertical cabinet door system according to one embodiment of the invention;

FIG. 3 is a perspective side view of a cabinet in a closed mode according to one embodiment of the invention

FIG. 4 is a perspective side view of a door mechanism in a closed mode according to one embodiment of the invention;

FIG. 5 is a perspective side view of a door mechanism in an open mode according to one embodiment of the invention; and

FIG. 6 is a side elevational view of a track plate according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

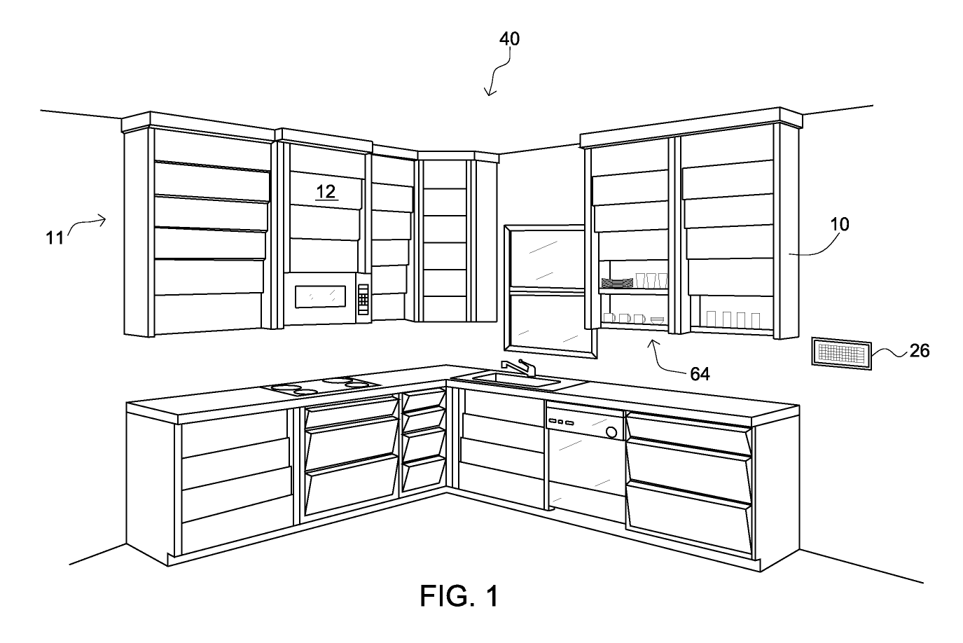

FIG. 1 illustrates an automated cabinet door system 40 configured to provide selectable access to contents stored therein, comprising a plurality of cabinets 11. Each cabinet 10 includes a plurality of overlapping horizontal slats 12. The plurality of overlapping horizontal slats 12 further comprise an inward stair-step configuration 30, wherein this configuration 30 provides vertical displacement of the horizontal slats 12. As illustrated in FIG. 1, the system 40 includes a touch screen interface 26 configured to provide programmable control instructions to each cabinet 10 and each individual horizontal slat 12 of the automated door system 40.

In operation of one embodiment of an automated cabinet door system 40, a user operates the touch screen interface 26 and programs control instructions to each cabinet 10, thereby controlling each horizontal slat 12 of each cabinet 10. The user may program the cabinet system 40 to open cabinets associated with various task, i.e. dishwashing, food preparation, etc., in addition to opening, closing, and locking all of the cabinets 10. In addition, the touch screen interface 26 controls each cabinet 10 separately or the cabinet system 40 all together.

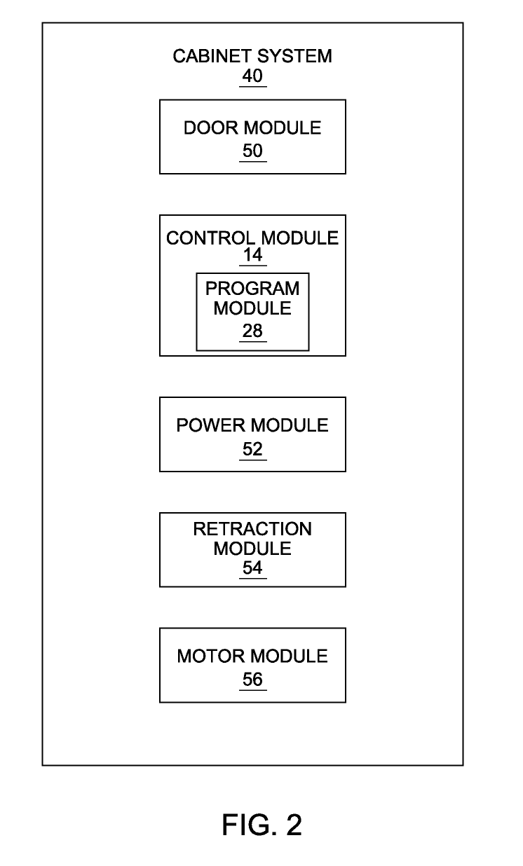

FIG. 2 illustrates a block diagram illustrating an automated cabinet door system 40 according to one embodiment of the invention, wherein the cabinet system 40, comprises a door module 50. The door module 50 is configured to operate each of the horizontal slats 12 of the cabinet door system 40. The system 40 further comprises a control module 14, in communication with the door module 50, wherein the control module 14 is configured to provide automated controls for each individual horizontal slat 12 of the cabinet door system 40. The system 40 also comprises a power module 52, in communication with the door module 50 and the control module 14, wherein the power module 52 is configured to provide power to the various modules, described herein, of the cabinet door system 40. As illustrated, FIG. 2, the cabinet door system 40 includes a retraction module 54, in communication with the control module 14, the power module 52, and the door module 50, wherein the retraction module 54 is configured to provide vertical movement of each of the individual slats 12 of the cabinet 10. Furthermore, the system 40 also includes a motor module 56, in communication with the door module 50, control module 14, the power module 52, and the retraction module 54, wherein the motor module 56 is configured to operate the retraction module 54 to vertically raise and lower the plurality of horizontal slats 12 of the cabinet door system 40.

In operation of another embodiment of the cabinet system 40, a user operates the control module 14 and programs control instructions to each of the cabinets 10 of the cabinet system 40. The control module 14 operates the motor module 56 to operate the retraction module 54, wherein the door module 50 is vertically displaced.

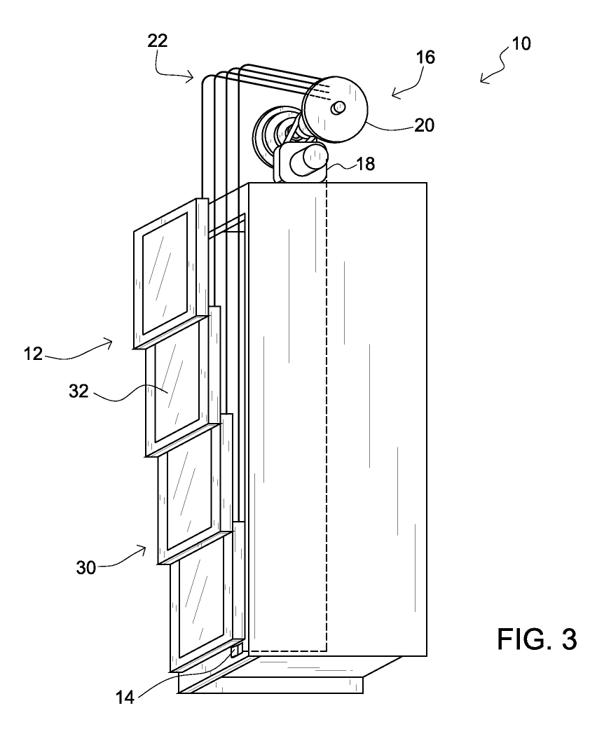

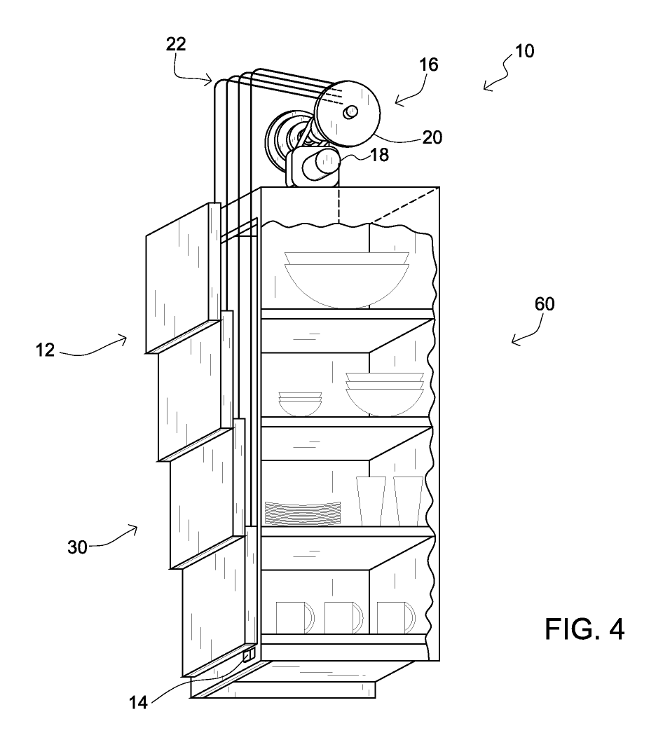

FIGS. 3 and 4 illustrate an automated cabinet 10 configured to provide selectable access to contents stored therein, comprising a plurality of horizontal slats 12. As illustrated in FIG. 3, the cabinet 10 includes a control module 14 configured to selectably provide control instructions to the plurality of horizontal slats 12. The cabinet 10 also includes a lifting system 16 coupled to the plurality of slats 12 and in communication with the control module 14; wherein the lifting system 16 is configured to raise and lower the plurality of slats 12 according to the control instructions. As illustrated in FIG. 4, the plurality of horizontal slats 12 are in a closed mode 60. In addition, the lifting system 16 comprises a rotor 18 coupled to a stepped wheel 20, wherein the rotor 18 and the stepped wheel 20 operate the vertical displacement of the >horizontal slats 12. The lifting system 16 further comprises a pulley system 22 configured to raise and lower the plurality of slats 12. The rotor 18 is configured to rotate the stepped wheel 20, thereby raising and lowering the plurality of horizontal slats 12. The stepped wheel 20 is configured to include a plurality of diameters, wherein the largest diameter of the stepped wheel 20 is coupled to the lowest horizontal slat and each preceding diameter is coupled to the next corresponding horizontal slat of the cabinet 10. Thereby, as the control module 14 operates the lifting system 16, the horizontal slat is vertically raised or lowered, wherein the stepped wheel 20 rotates and the pulley system 22 is wound around the diameters of the stepped wheel 20, thereby raising the lowest horizontal slat first and then the others respectively.

In operation of one embodiment of the automated cabinet 10, a user operates the control module 14, wherein each individual slat 12 is vertically raised or lowered by the lifting system 16. As illustrated in FIG. 3, the horizontal slats 12 each include a transparent surface 32, wherein the user may see through the transparent surface 32 and view the contents within the cabinet 10. The user may view the contents of the cabinet 10 without opening the horizontal slats 12 for each cabinet 10. As illustrated in FIG. 4, the control module 14 provides control instructions to close the horizontal slats 12 of the cabinet 10, wherein the cabinet 10 is in a closed mode 60.

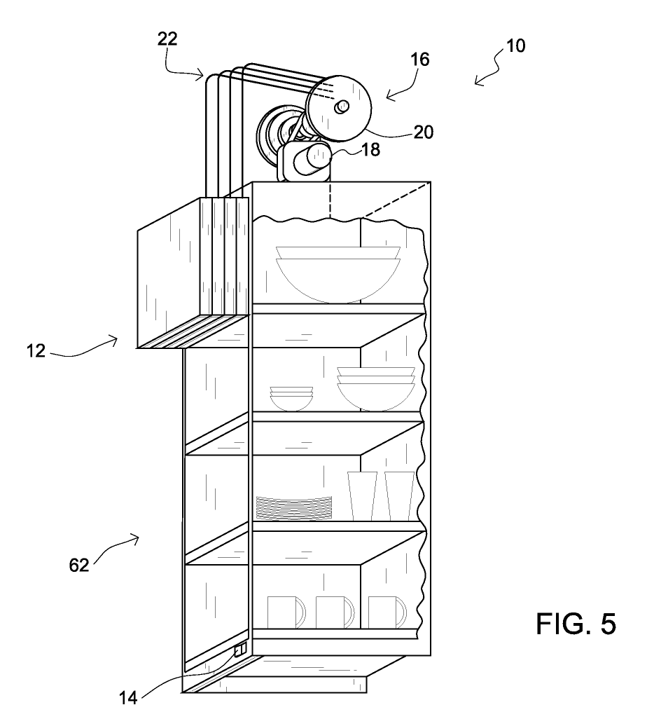

FIG. 5 illustrates an automated cabinet 10, according to one embodiment of the invention, wherein the plurality of horizontal slats 12 is in an open mode 62. In addition, the cabinet 10 is also configured to be in a partially open mode 64 as illustrated in FIG. 1, wherein each of the horizontal slats 12 may be open at any one time. In operation of one embodiment of the automated cabinet 10, a user operates the control module 14, wherein each individual slat 12 is vertically raised or lowered by the lifting system 16. As illustrated in FIG. 5, the control module 14 provides control instructions to open the horizontal slats 12 of the cabinet 10, wherein the cabinet 10 is in a open mode 62.

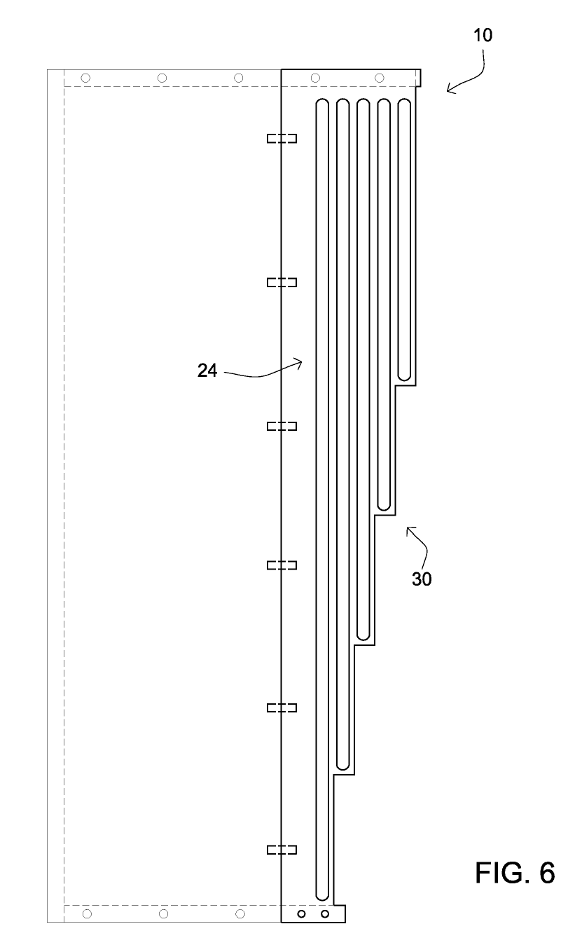

FIG. 6 illustrates an automated cabinet 10, according to one embodiment of the invention, wherein the cabinet 10 includes a plurality of tracks 24 configured to guide the plurality of slats 12 when raised and lowered according to the control instructions. As illustrated in FIG. 6, the plurality of tracks 24 are also configured to enable the plurality of horizontal slats 12 to be selectably removable from the cabinet 10. The plurality of horizontal slats 12 includes grooved exteriors, wherein the grooves are configured to be guided by the plurality of tracks of the lifting system 16.

In operation of one embodiment of the plurality of tracks 24, one skilled in the art would appreciate that the plurality of horizontal slats 12 are individually selectably removable, wherein a user may interchange the plurality of horizontal slats 12 to create a particular design or configuration. Such may be facilitated by including snaps, belts, flexible ridges, clips, clamps, track and guide, groove and track, ball and socket, etc. coupled to one or more of the horizontal slats 12, tracks 24, retraction system, and lifting system 16. Each horizontal slat 12 is configured to decouple from the pulley system. In addition, the inward stair-step configuration 30 enable the horizontal slats 12 to be individually removable from the cabinet 10, wherein the outer most horizontal slat is removed first and thereby enabling the other horizontal slats to removed in succession.

In operation of one embodiment of an automated cabinet door system 40, a user programs control instructions via the touch screen interface 26; wherein each cabinet 10 is controlled through the touch screen interface. Examples of control instructions may be but not limited to the examples below.

### EXAMPLE 1

A user programs the control module to a dishwashing mode, wherein the control module is configured to open all the cabinets that are used to store plates, dishes, silverware, glasses, etc.

### EXAMPLE 2

A user programs the control module to a lock mode, wherein the control module disables particular cabinets of the cabinet system, such as the drug prescription cabinet or the cleaning cabinet, so that access to particular cabinets will be denied without an entry code.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the cabinet door system includes a touch screen interface, one skilled in the art would appreciate that the interface may also include audio sensors and motion sensors; wherein the user uses audio control instructions to control the cabinet system. In addition, each cabinet may include a motion sensor disposed in front of each horizontal slat, wherein motion would operate and control each horizontal slat of the cabinet system.

Additionally, although the figures illustrate a cabinet door system, one skilled in the art would appreciate that the system may be integrated for doorways or entry ways and still perform its intended function.

It is also envisioned that one skilled in the art would appreciate that the control module is a wireless remote control, wherein the user may activate the cabinet system through the wireless remote control.

It is expected that there could be numerous variations of the design of this invention. An example is that the horizontal slats may be interchanged. One non-limiting example may be that the horizontal slats may be comprised of a plurality of material, such as but not limited to: wood, plastic, metal, metal alloys, transparent magnetic surface, plastic composite; including material with various finishes, such as but not limited to glossy, fine, dull, water resistant, etc. and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. An automated cabinet configured to provide selectable access to contents stored therein, comprising:
a) a plurality of overlapping horizontal slats;
b) a control module configured to selectably provide control instructions; and
c) a lifting system coupled to the plurality of slats and in communication with the control module; wherein the lifting system is configured to raise and lower the plurality of slats according to the control instructions.

2. The cabinet of claim 1, wherein the plurality of overlapping slats are individually selectably removable.

3. The cabinet of claim 2, wherein the lifting system further comprises a rotor coupled to a stepped wheel.

4. The cabinet of claim 3, wherein the lifting system further comprises a pulley system configured to raise and lower the plurality of slats.

5. The cabinet of claim 4, wherein the lifting system further comprises a plurality of tracks configured to guide the plurality of slats when raised and lowered according to the control instructions.

6. The cabinet of claim 5, wherein the control module further comprises a touch screen interface.

7. The cabinet of claim 6, wherein the control module further comprises a program module, in communication with the touch screen interface, configured to provide programmable control instructions.

8. The cabinet of claim 7, wherein the plurality of overlapping horizontal slats further comprises an inward stair-step configuration.

9. The cabinet of claim 8, wherein the plurality of overlapping horizontal slats further comprises a transparent surface.

10. An automated cabinet configured to provide selectable access to contents stored therein, comprising:
a) a plurality of overlapping horizontal slats;
b) a control module configured to selectably provide control instructions; and
c) a lifting system coupled to the plurality of slats and in communication with the control module; wherein the lifting system is configured to raise and lower the plurality of slats according to the control instructions.

11. The cabinet of claim 10, wherein the plurality of overlapping slats are individually selectably removable.

12. The cabinet of claim 10, wherein the lifting system further comprises a rotor coupled to a stepped wheel.

13. The cabinet of claim 10, wherein the lifting system further comprises a pulley system configured to raise and lower the plurality of slats.

14. The cabinet of claim 10, wherein the lifting system further comprises a plurality of tracks configured to guide the plurality of slats when raised and lowered according to the control instructions

15. The cabinet of claim 10, wherein the control module further comprises a touch screen interface.

16. The cabinet of claim 10, wherein the control module further comprises a program module, in communication with the touch screen interface, configured to provide programmable control instructions.

17. The cabinet of claim 10, wherein the plurality of overlapping horizontal slats further comprises an inward stair-step configuration.

18. The cabinet of claim 10, wherein the plurality of overlapping horizontal slats further comprises a transparent surface.

19. An automated door system configured to provide selectable access to contents stored therein, comprising:
a) a plurality of overlapping horizontal slats; where in the plurality of overlapping slats are individually selectably removable; wherein the plurality of overlapping horizontal slats further comprise an inward stair-step configuration; wherein the plurality of overlapping horizontal slats further comprise a transparent surface;
b) a control module configured to selectably provide control instructions; wherein the control module further comprises:
b1) a touch screen interface; and
b2) a program module, in communication with the touch screen interface, configured to provide programmable control instructions; and
c) a lifting system coupled to the plurality of slats and in communication with the control module; wherein the lifting system is configured to raise and lower the plurality of slats according to the control instructions; wherein the lifting system further comprises:
c1) a rotor coupled to a stepped wheel;
c2) a pulley system configured to raise and lower the plurality of slats; and
c3) a plurality of tracks configured to guide the plurality of slats when raised and lowered according to the control instructions.
